(19) United States
(12) Patent Application Publication
(10) Pub. No.: US 2017/0354293 A1
(43) Pub. Date: Dec. 14, 2017

(54) SILICONE LINER FOR SLOW COOKER

(71) Applicant: Lisa Voyles, Hendersonville, TN (US)

(72) Inventor: Lisa Voyles, Hendersonville, TN (US)

(21) Appl. No.: 15/618,559

(22) Filed: Jun. 9, 2017

Related U.S. Application Data
(60) Provisional application No. 62/348,355, filed on Jun. 10, 2016.

(51) Int. Cl. A47J 36/16; A23L 5/10; A47J 36/04

(52) U.S. Cl. CPC A47J 36/16; A47J 36/04; A23L 5/10; A23V 2002/00

(57) ABSTRACT

A slow cooker liner. The slow cooker liner includes a substantially flat base having an outer edge forming an oval shape. A sidewall extends vertically from the outer edge of the base, the sidewall having an oblong frusto conical shape. The sidewall includes a bottom rim having a smaller diameter than a top rim. The bottom rim is attached to the base and the top rim forms an opening leading into a receptacle of the liner. An inner and outer surface of the sidewall includes a constant taper from the bottom rim to the top rim. The substantially flat base and the sidewall are made of silicone.

### CROSS-REFERENCE TO RELATED APPLICATION

This application claims the benefit of priority of U.S. provisional application No. 62/348,355, filed Jun. 10, 2016, the contents of which are herein incorporated by reference.

### BACKGROUND OF THE INVENTION

The present invention relates to slow cookers and, more particularly, to a silicone liner used with a slow cooker.

A slow cooker is a countertop electrical cooking appliance used to simmer at a lower temperature than other cooking methods. This facilitates unattended cooking for many hours of dishes that would otherwise be boiled and other dishes (including beverages, desserts, and dips). A wide variety of dishes can be prepared in slow cookers, including ones typically made quickly. Occasionally food sticks to the side of slow cookers while in use, which makes cleaning the slow cooker difficult. To prevent this from happening, slow cooker liners are used. Current slow cooker liners are disposable and are made of materials that may release harmful chemicals in the food.

As can be seen, there is a need for a re-usable and safe liner that prevents the slow cooker from getting dirty.

### SUMMARY OF THE INVENTION

In one aspect of the present invention, a slow cooker liner comprises: a substantially flat base comprising an outer edge forming an oval shape; a sidewall extending vertically from the outer edge of the base, the sidewall having an oblong frusto conical shape comprising a bottom rim having a smaller diameter than a top rim, wherein the bottom rim is attached to the base and the top rim forms an opening, wherein an inner and outer surface of the sidewall comprises a constant taper from the bottom rim to the top rim, wherein the substantially flat base and the sidewall are made of silicone.

In another aspect of the present invention, a method of using a slow cooker liner comprises: placing a slow cooker liner within a slow cooker, wherein the slower cooker liner comprises: a substantially flat base comprising an outer edge; a sidewall extending vertically from the outer edge of the base, the sidewall comprising a bottom rim and a top rim, wherein the bottom rim is attached to the base and the top rim forms an opening leading into the sidewall, wherein the substantially flat base and the sidewall are made of silicone; placing food within the slow cooker liner; placing a lid over the slow cooker, wherein the top rim of the slow cooker liner is disposed entirely underneath the lid; and powering the slow cooker, thereby cooking the food.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention in use;

FIG. 2 is a perspective view of an embodiment of the present invention; and

FIG. 3 is a section view of an embodiment of the present invention taken from 3-3 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a removable silicone insert to put inside a slow cooker to keep food from burning or sticking to the slow cooker. The silicone insert of the present invention is placed inside the slow cooker and then food is placed within the silicone insert and cooked. The present invention allows a user to cook food using a slow cooker without burning or sticking food to the slow cooker which allows for an easier cleanup. The insert may include a non-stick surface, which keeps the food from burning or sticking to the insert as well.

Once the food has been prepared and served, the silicone liner may be pulled out and washed in the dishwasher or with warm water and soap. The silicone liner is re-usable and therefore better for the environment as compared to plastic liners that are thrown away. Further, the silicone liners are made of food grade material and are bisphenol A (BPA) free, thereby making the liners safe to use.

A slow cooker includes a lidded round or oval cooking pot made of glazed ceramic or porcelain, surrounded by a housing, usually metal, containing an electric heating element. The lid may be made of glass, and seated in a groove in the pot edge; condensed vapor collects in the groove and provides a low-pressure seal to the atmosphere. The “crock” or ceramic pot itself acts as both a cooking container and a heat reservoir. Slow cookers come in capacities from 500 mL (17 US fl oz) to 7 L (7.4 US qt). Because the heating elements are generally located at the bottom and often also partway up the sides, most slow cookers have a minimum recommended liquid level to avoid uncontrolled heating.

The slow cooker may include two or more heat settings (e.g., low, medium, high, and sometimes a “keep warm” setting) and may further include continuously variable power. The slow cooker may include no temperature control and deliver a constant heat to the contents. The temperature of the contents rises till it reaches boiling point, at which point the energy goes into gently boiling the liquid closest to the hot surface. At a lower setting, it may just simmer at a temperature below the boiling point.

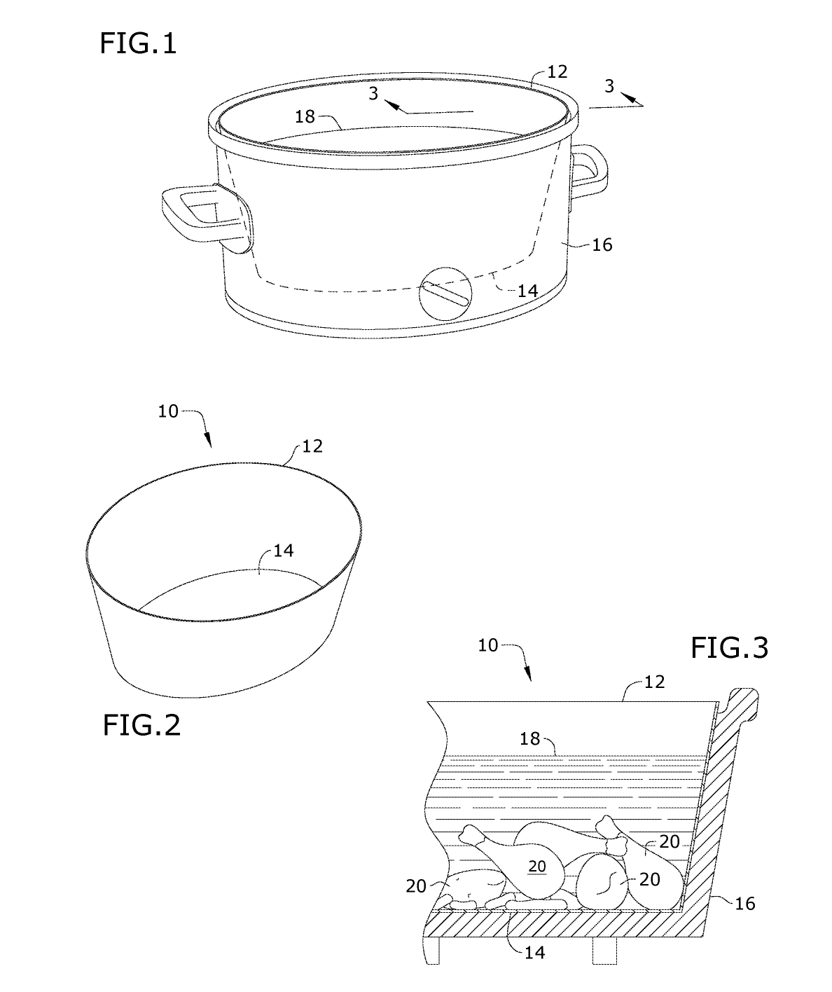

Referring now to FIGS. 1 through 3, the present invention includes a slow cooker liner 10. The slow cooker liner 10 includes a substantially flat base 14 having an outer edge forming an oval shape. A sidewall 15 extends vertically from the outer edge of the base 14, the sidewall having an oblong frusto conical shape. The sidewall 15 includes a bottom rim 17 having a smaller diameter than a top rim 12. The bottom rim 17 is attached to the base 14 and the top rim 12 forms an opening leading into a receptacle of the liner 10. An inner and outer surface of the sidewall includes a constant taper from the bottom rim 17 to the top rim 12. The substantially flat base 14 and the sidewall 15 are made of silicone. The silicone is of a thickness so that the liner 10 self-retains the oblong frusto-conical shape.

A method of using a slow cooker liner 10 may include the following steps: placing a slow cooker liner 10 within a slow cooker 16; placing solid food 20 and/or broth 18 within the slow cooker liner 10; placing a lid over the slow cooker 16 so that the top rim 12 of the slow cooker liner 10 is disposed entirely underneath the lid; and powering the slow cooker, thereby cooking the food 20. The steps may further include: removing the food 20 from the slow cooker 16; removing the slow cooker liner 10 from the slow cooker 16; and washing the slow cooker liner 10. The step of washing the slow cooker liner 10 may include hand washing with water and soap or placing the slow cooker liner in a dish washer and powering the dish washer.

To make the present invention, a mold may be utilized. The mold may have the same dimensions as an inner wall of a slow cooker. A liquid silicone may be injected into the mold at a desired thickness to create the liner. The silicone is then screen printed and or painted.

The mold is a replica of the slow cooker's bowl that the silicone liner will be going into. These can range in a variety of sizes and shapes depending on the slow cooker's manufacturer. Once the silicone is poured into the mold and formed, the liner can then be used in the slow cooker. The liner can be used on all temperature settings on the slow cooker and be thrown into the dishwasher for easy cleanup.

The liner of the present invention can be sized either rectangle, round or square with measurements of 2 qt, 2.5 qt, 3 qt, 3.5 qt, 4 qt, 4.5 qt, 5 qt, 5.5 qt, 6 qt, 6.5 qt, 7 qt, 7.5 qt and 8 qt slow cookers or crock pots. The present invention can also be manufactured at 16 ounces or the 1.5 ounce sizes. The present invention may be made thinner or thicker depending on heating ability in the slow cooker from sizes 0.001 inches and above. The present invention may also come in a variety of colors.

It should be understood, of course, that the foregoing relates to exemplary embodiments of the invention and that modifications may be made without departing from the spirit and scope of the invention as set forth in the following claims.

What is claimed is:

1. A slow cooker liner comprising:
a substantially flat base comprising an outer edge forming an oval shape;
a sidewall extending vertically from the outer edge of the base, the sidewall having an oblong frusto conical shape comprising a bottom rim having a smaller diameter than a top rim, wherein the bottom rim is attached to the base and the top rim forms an opening, wherein an inner and outer surface of the sidewall comprises a constant taper from the bottom rim to the top rim, wherein
the substantially flat base and the sidewall are made of silicone.

2. A method of using a slow cooker liner comprising:
placing a slow cooker liner within a slow cooker, wherein the slower cooker liner comprises:
a substantially flat base comprising an outer edge;
a sidewall extending vertically from the outer edge of the base, the sidewall comprising a bottom rim and a top rim, wherein the bottom rim is attached to the base and the top rim forms an opening leading into the sidewall, wherein
the substantially flat base and the sidewall are made of silicone;
placing food within the slow cooker liner;
placing a lid over the slow cooker, wherein the top rim of the slow cooker liner is disposed entirely underneath the lid; and
powering the slow cooker, thereby cooking the food.

3. The method of claim 2, further comprising the steps of:
removing the food from the slow cooker;
removing the slow cooker liner from the slow cooker; and
washing the slow cooker liner.

4. The method of claim 3, wherein the step of washing the slow cooker liner comprises placing the slow cooker liner in a dish washer and powering the dish washer.

5. The method of claim 2, wherein the sidewall comprises an oblong frusto conical shape, wherein an inner and outer surface of the sidewall comprises a constant taper from the bottom rim to the top rim.
